(19) United States
(12) Patent Application Publication
(10) Pub. No.: US 2014/0341575 A1
(43) Pub. Date: Nov. 20, 2014

(54) SIGNAL MANIPULATOR FOR A QUANTUM COMMUNICATION SYSTEM

(71) Applicant: Kabushiki Kaisha Toshiba, Minato-ku (JP)

(72) Inventors: Iris CHOI, Cambridgeshire (GB); Zhiliang YUAN, Cambridge (GB); Andrew James SHIELDS, Cambridge (GB)

(73) Assignee: Kabushiki Kaisha Toshiba, Minato-ku (JP)

(21) Appl. No.: 14/196,423

(22) Filed: Mar. 4, 2014

(30) Foreign Application Priority Data
May 14, 2013 (GB) 1308649.1

(51) Int. Cl. H04B 10/70; H04J 14/02

(52) U.S. Cl. CPC H04B 10/70; H04J 14/0221
USPC 398/51

(57) ABSTRACT

A signal manipulator, comprising:
an input for multiplexed signal,
a demultiplexer for separating the multiplexed signal into separate components,
a retransmitter unit being configured to receive a first component from the separated components and retransmit said received first component at a higher power than it is received;
a bypass channel being configured to receive a second component from the components separated by the demultiplexer; and
a multiplexer for multiplexing the first and second components,
wherein the retransmitter is configured to regulate the power of the first component such that the power of the multiplexed signal leaving the multiplexer is −5 dBm or less.

### FIELD

Embodiments of the present invention are concerned with the field of quantum communication systems.

### BACKGROUND

In quantum communication systems, encoded single quanta, such as single photons, are transmitted between a sender and a receiver. Each photon carries one bit of information encoded on a property of the photon, such as its polarisation, phase, energy or time.

Quantum key distribution (QKD) is one such example of a quantum communication system. Photons are used to share a cryptographic key between two parties: “Alice” the transmitter and “Bob” the receiver. This technique has the advantage of providing a test of whether any part of the key can be known to an eavesdropper (“Eve”) as the laws of quantum mechanics dictate that measurement of the photons by Eve causes a change to the state of some of the photons.

Unlike a classical signal, a quantum signal cannot be intercepted without causing detectable disturbance to the quantum signal transmission. For example, in the single photon case, with equal weighting of 2 non-orthogonal bases, intercepting each single quanta by measurement and replacing it with another photon will cause a quantum bit error rate of 25% on average.

In addition to single photons, quantum communication systems can be based also on encoding information upon quantum continuous variables. The corresponding QKD protocols are referred to as continuous variable QKD (CV-QKD). Similarly to the single photon protocols, intercepting and resending the photons increases the channel noise, thereby increasing the channel error.

It is desirable for quantum channels to co-exist with classical channels. Indeed, the technique of quantum key distribution requires Alice and Bob to communicate using classical signals in addition to quantum signals. Other examples include metropolitan networks and dedicated inter-bank networks where data traffic is present and high security is needed.

Classical and quantum channels may be transmitted together along a single optical fibre using the process of multiplexing. Multiplexing is a process of combining a number of signals, including, but not limited to, bidirectional signals, into a single signal for transmission. Wavelength division multiplexing, whereby different wavelengths of light are used to transmit different signals, is an example of one type of multiplexing.

When quantum and classical channels are multiplexed together, Raman scattering of photons is generated by the high power classical lasers used to transmit the classical signals. This Raman scattering is proportional to launch power and increases with optical fibre transmission distance. The minimum launch power of a classical laser is set by the receiver sensitivity and transmission distance; if the launch power is too small for the distance of transmission, the received signal will be too low for error-free data communication. Raman scattering therefore limits quantum/classical channel co-existence as, beyond a certain distance, the minimum launch power required will generate sufficient Raman noise to corrupt the quantum channel signal. Conventional techniques in suppressing Raman noise generated by classical lasers in optical fibre involve spectral filtering and data laser power control. In addition, Raman scattering is a broadband phenomenon. The spectral width of Raman scattering is >200 nm wide. Raman scattering needs to be controlled in order to operate a quantum channel within 200 nm of the classical channels.

Currently, the maximum distance of quantum/classical multiplexed signal transmission is limited to 90 km for the case of a QKD signal co-existing with a 1.25 GB/s signal. This distance will be reduced when higher classical data rates or more data channels are used.

### BRIEF DESCRIPTION OF THE DRAWINGS

Embodiments will now be described with reference to the following figures:

FIG. 1 is a schematic of a quantum communication system with a quantum channel multiplexed with bi-directional classical data channels;

FIG. 2 is a schematic of a quantum communication system including a signal manipulator according to an embodiment;

FIG. 3 is a graph showing data laser launch power as a function of fibre length;

FIG. 4a is a schematic of a single channel signal manipulator according to an embodiment;

FIG. 4b is a schematic of the part of the single channel signal manipulator responsible for retransmitting the classical signal according to an embodiment;

FIG. 5a is a schematic of a two-channel bidirectional signal manipulator according to an embodiment;

FIG. 5b is a schematic of the part of the two-channel bidirectional signal manipulator responsible for retransmitting the classical signal according to an embodiment;

FIG. 6a is a schematic of a multi-channel signal manipulator according to one embodiment;

FIG. 6b is a schematic of the part of the multi-channel signal manipulator responsible for retransmitting the classical signal according to an embodiment;

FIG. 7 shows the application of a signal manipulator according to one embodiment in a network scenario; and

FIG. 8 shows an example of application of a signal manipulator according to one embodiment in a long haul transmission link scenario.

### DETAILED DESCRIPTION OF THE DRAWINGS

In an embodiment, a signal manipulator is provided comprising: an input for multiplexed signal, a demultiplexer for separating the multiplexed signal into separate components, a retransmitter unit being configured to receive a first component from the separated components and retransmit said received first component at a higher power than it is received; a bypass channel being configured to receive a second component from the components separated by the demultiplexer; and a multiplexer for multiplexing the first and second components, wherein the retransmitter is configured to regulate the power of the first component such that the power of the multiplexed signal leaving the multiplexer is −5 dBm or less.

The retranmission process may be realised by optical or electrical means or both. For example, the optical signal may be converted to an electrical signal by photo-detection. It may then be converted to an optical signal by a transponder. In an alternative embodiment, the retransmission will be a simple amplification of the received first component.

In a further embodiment, the power of the multiplexed signal leaving the multiplexer is −10 dBm or less, in a yet further embodiment, −20 dBm or less.

In one embodiment the first component is configured to carry information in accordance with classical information protocols and the second component is configured to carry information in accordance with quantum communication protocols. Here, the first component has a higher power than the second component. Typically, for QKD schemes which employ a single photon as the quantum information carrier, the second component may have a power of −70 dBm or less; for other higher-photon number QKD schemes, such as CV-QKD, the typical power is −50 dBm or less. In either case, the first component may have a power of −40 dBm or greater. The second component be transmitted in the form of signal light pulses where the average number of photons in each pulse is less than one. The second signal may be transmitted in the form of signal light pulses comprising up to several hundred photons as in the CV-QKD scheme. In either case, intercepting and resending the quantum signal causes an increase in channel error which ceases the secure key transfer.

The first signal carries classical information. The first signal may be repeated in an intermediate location between the transmitter and receiver without loss of any information. Repetition of the first signal may be realised by receiving and retransmitting the signal, or by signal amplification. In the case of intermediate repetition, the first signal may be launched and retransmitted at a power that is much less than the launch power of a signal transmitted without a signal manipulator. The launch power of the first signal may be selected to ensure an error-free data operation. The launch power of the first signal may be selected to ensure an error rate which is acceptable by conventional classical communication protocol, for example with a bit error rate of 1E-09 or less.

The first signal may comprise a mix of a plurality of signals. In such an embodiment, the retransmitter unit is configured to receive a plurality of components from said demultiplexer, the retransmitter unit being configured to regulate the power of received plurality of components such that the power of the multiplexed signal leaving the multiplexer is −5 dBm or less.

In a further embodiment, the retransmitter comprises a plurality of retransmission units arranged in parallel, such that each component is allocated to its own retransmission unit. Each retransmission unit may comprise a receiver and a transmitter. In a further embodiment, the retransmitter comprises one or a plurality of receivers. The retransmitter may comprise one or a plurality of transmitters. The retransmitter unit may comprise a separator and a recombiner.

The component signals of the first signal may be travelling in the same direction or in opposing directions. The first signal may be travelling in the same direction as the second signal or it may be travelling in an opposite direction. In an embodiment, the signal manipulator is, configured to manipulate signals travelling in a first direction and a second direction, wherein the first direction is opposite to the second direction, the retransmitter being configured to regulate the power of the first component regardless of whether it is travelling in the first direction or the second direction, the demultiplexer being configured to demultiplex multiplexed signals travelling in a first direction and pass them to the retransmitter, the demultiplexer being configured to multiplex signals received from the retransmitter and bypass channel travelling in a second direction, the mullitplexer being configured to multiplex signals received from the retransmitter and bypass channel travelling in a first direction and to demultiplex multiplexed signals travelling in a second direction and pass them to the retransmitter.

Signal repetition can enable a lower launch power to be used to transmit the first signal while still achieving the same transmission distance. A lower launch power reduces the Raman scattering. However, the second signal, which carries quantum information, cannot be repeated or amplified without introducing errors into the information. A conventional signal repeater cannot, therefore, be used directly in the case where quantum and classical signals are multiplexed together. Instead, a signal manipulator designed to enable different treatment of the first signal and second signal is required.

In an embodiment, the retransmitting power is determined by the transmission loss of next section fibre and the sensitivity of next photoreceiver. For example, if the next section of fibre has 10 dB loss, and the photosensitivity of next photoreceiver is −30 dBm, the retransmitting power must be at least −20 dBm.

The signal manipulator regenerates the component of the first signal which is travelling in the opposite direction to the second signal. The regeneration process may include, but is not limited to, signal amplification, re-shaping and re-timing. Signal amplification can be performed using optical amplifiers, for example, an Erbium Doped Fibre Amplifier (EDFA) or a semiconductor optical amplifier (SOA). Optical amplifiers are well known in the art and will not be discussed further here.

Signal re-shaping is the process of changing the waveform of transmitted pulses. This is in order to make a transmitted signal better suited to its respective communication channel. In the presence of excess jitter, signal re-timing techniques can be used to realign a pulse in time. This can be done with standard techniques such as those employing a signal re-shaper plus an optical switch. These techniques are well known in the art and will not be discussed further here.

Use of the signal manipulator helps to suppress Raman scattering in the case where the first signal is a classical signal and the second is a quantum signal. The effect of Raman scattering of photons is most pronounced when the scattering is in “backward” direction, namely when classical and quantum signals are transmitted in opposite directions. In cases where the quantum signal is transmitted in the reverse direction to the classical signal, high Raman backward scattering coincides with the region in which the quantum signal is at its weakest, namely near the quantum signal detector (“Bob”).

In one embodiment, the multiplexer, demultiplexer, retransmitter and bypass channel are provided by a reconfigurable add/drop multiplexer (ROADm) which is configured to regulate the power of the first component such that the power of the multiplexed signal leaving the multiplexer is −5 dBm or less.

In a further embodiment the manipulator is configured externally to regulate the power as required. In a further embodiment, the manipulator is configured to self-regulate the power of the output signal. Such a signal manipulator may further comprise a detector to determine the input power of the multiplexed signal and a processor configured to regulate the power of the first component such that the power of the multiplexed signal leaving the multiplexer is −5 dBm or less.

In another embodiment, a quantum communication is provided, the quantum communication system comprising: a source unit and a signal manipulator as described above, said source unit comprising: a source of quantum signals; a source of classical signals; and a mulitiplexing unit, configured to multiplex said quantum signals and said classical signals into a multiplexed signal; the system further comprising an optical fibre configured to deliver said multiplexed signal from said source unit to said signal manipulator.

The source unit may be configured to output said multiplexed signal with a power of −5 dBm or less.

In an embodiment, the system further comprises receiver for the signal which is output by the multiplexer of the signal manipulator.

Further embodiments of the system may comprise a plurality of signal manipulators. The signal manipulators may be spaced such that there is 100 km or less between adjacent signal manipulators. The signal manipulators may be spaced such that there is 10 km or more between adjacent signal manipulators. In an embodiment, the signal manipulators are arranged in series.

The system may be provided in a circular network. The system may also be used in a long haul network having a length of at least 500 km.

In yet another embodiment, the present invention provides a method of repeating a signal, the method comprising: receiving a multiplexed signal, demultiplexing the multiplexed signal into separate components, receiving a first component of the demultiplexed signal and retransmitting said received first component at a higher power than it is received; receiving a second component from the components separated by the demultiplexer and directing it into a bypass channel; and multiplexing the first and second components to produce a multiplexed output signal, wherein power at which the first component is retransmitted is controlled such that the power of the multiplexed output signal when leaving the multiplexer is −5 dBm or less.

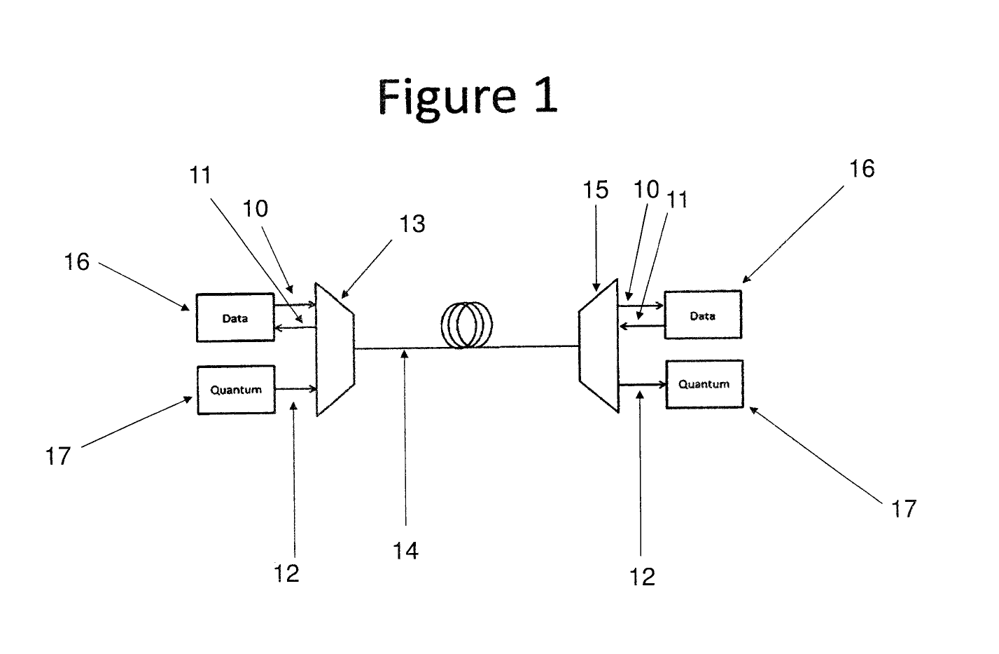

FIG. 1 shows a communication system in which quantum and classical channels co-exist. By a quantum channel we refer to a path along which a signal is transmitted by encoded weak light pulses in such a way that any interception by a third party will inevitably modify the information and thus enable detection. Each bit of information is encoded on a property of the pulse, such as its polarization. For QKD schemes that deploy single photon schemes, each pulse contains on average much less than one photon. In an embodiment the power of quantum signals is −70 dBm or less. For QKD schemes, such as CV-QKD, there may be up to several hundred photons in each pulse. By a classical data channel we refer to a path along which a signal which may comprise data is transmitted classically as light radiation. Classical signals contain more photons and therefore have a higher power than quantum signals. Classical signals can be intercepted and resent without creating detectable errors. In an embodiment the classical signal is launched at a power of −40 dBm or greater. In a further embodiment, the data rate for the classical signal is 1.25 Gb/s.

The system comprises bi-directional classical data channels 10 and 11, which transmit data 16 as a classical signal; a uni-directional quantum channel 12, which transmits a quantum signal 17; and two spectral couplers 13 and 15. Spectral couplers 13 and 15 multiplex together and demultiplex apart signals 10, 11 and 12, such that between spectral couplers 13 and 15, only a single multiplexed signal 14 is transmitted. Signal 14 contains comprises all three signals 10, 11 and 12. Typical examples of the multiplexed channel 14 include Coarse Wavelength Division Multiplex (CWDM) and Dense Wavelength Division Multiplex (DWDM).

In order to suppress Raman scattering in such a configuration, the classical laser power used to transmit signals 10 and 11 is restricted. This restriction in turn limits the maximum transmission distance of multiplexed signal 14.

The retransmitting power is determined by the transmission loss or attenuation of the next section fibre and the sensitivity of the next photoreceiver. For example, if the attenuation of the next section of fibre results in a 10 dB loss, and the photosensitivity of next photoreceiver is −30 dBm and the retransmitting power must be at least −20 dBm.

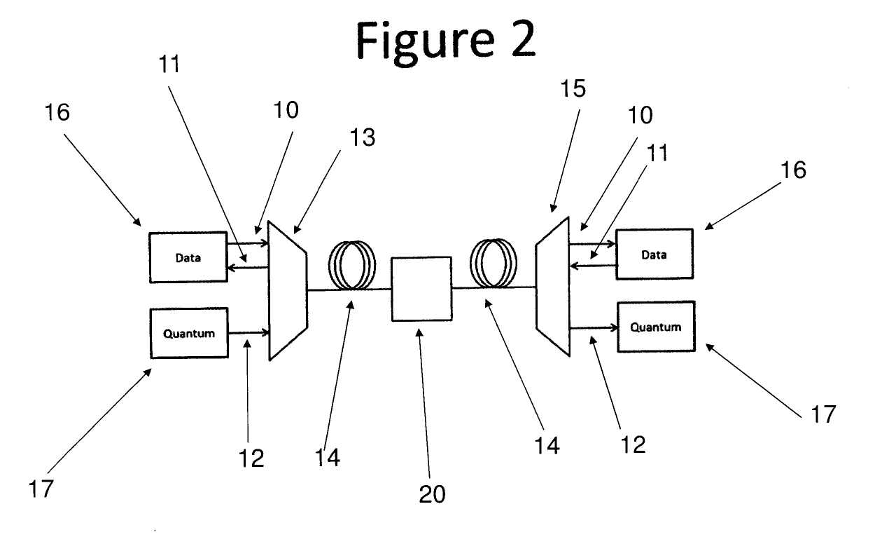

FIG. 2 shows a communication system with co-existing quantum and classical channels according to an embodiment of the present invention. The system comprises bi-directional classical data channels 10 and 11, which transmit data 16 as a classical signal; a uni-directional quantum channel 12, which transmits a signal 17 as encoded single quanta; two spectral couplers 13 and 15; and a signal manipulator according to an embodiment of the present invention. Spectral couplers 13 and 15 multiplex together and demultiplex apart signals 10, 11 and 12, such that between spectral couplers 13 and 15, only a single multiplexed signal 14 is transmitted. Signal 14 comprises all three signals 10, 11 and 12.

In the embodiment of FIG. 2, the quantum 12 and classical 10, 11 channels are typically optical fibres. These interface directly with the spectral filters 13 and 15 which are typically coarse wavelength division multiplexers or dense wavelength division multiplexers. Spectral filters 13 and 15 further interface directly with multiplexed channel 14 which is typically an optical fibre.

Channel 14 further interfaces directly with the signal manipulator such that during transmission between spectral couplers 13 and 15, the multiplexed signal is directed into the signal manipulator 20. The signal manipulator 20 manipulates the classical signals/components 10 and 11 comprising the multiplexed signal 14 before retransmitting them.

In an embodiment, the manipulator regulates the power of the classical signals such that the power of the multiplexed signal output by the manipulator is −5 dBm or less.

The manipulation may comprise one or more amplification, signal re-timing, re-shaping and re-shaping. The manipulation may not be limited to amplification, signal re-timing, re-shaping and re-shaping. The signal manipulator then reinserts said manipulated classical signals into the multiplexed signal 14. The multiplexed signal 14 is then directed out of the signal manipulator.

In an embodiment, the signal manipulator retransmits classical signals 10 and 11 with a laser launch power that allows the signals to be received at the end of their respective channels but is sufficiently low as to limit Raman scattering. In a further embodiment, the signal manipulator amplifies classical signals 10 and 11 such that they are retransmitted at a higher power than the power at which they were received. However, the signals are regulated so that the maximum power of the signal output by the manipulator is −5 dBm.

Because each classical signal is retransmitted by the signal manipulator, the initial laser launch power required for transmission of data through channels 10 and 11 is that sufficient to be received at the signal manipulator. This is in contrast to the conventional example of FIG. 1, where the initial launch power required for transmission of data through channels 10 and 11 must be sufficient to be received at the end of their respective channels. If the signal manipulator is located closer to the transmission point of the classical signal than the point at which the classical signal is received at the end of the channel, a smaller initial laser launch power is required than for a system with the same configuration but without a signal manipulator. Equivalently, a longer distance of transmission can be achieved for a system with the same laser launch power and the same configuration but without a signal manipulator.

Thus, the inclusion of the signal manipulator according to an embodiment of the present invention in a quantum communication system enables the optimization of the laser launch power of the classical signals 10 and 11 for quantum/classical signal co-existence; a longer distance of transmission can be achieved using a laser launch power that is sufficiently low to suppress Raman scattering. In an embodiment, the first signal/component is retransmitted by the signal manipulator with a launch power that ensures the classical data channel is error free or with an error rate which is acceptable within the requirements set by conventional classical communication protocols, for example with a bit error rate of 1E-09. In an embodiment, depending on the classical protocol used, the allowable error rate of 1E-09 could be improved to 1E-03 with the help of Forward Error Correction code.

The embodiment of FIG. 2 comprises a single signal manipulator in a quantum communication system. In a further embodiment a quantum communication system comprises a plurality of signal manipulators arranged in series, thus further optimizing the quantum classical co-existence distance. In an embodiment, each signal manipulator manipulates the classical signal by one or more of amplification, signal re-timing, re-shaping and re-generation. The signal manipulator may manipulate the signal using a method other than amplification, signal re-timing, re-shaping. The signal is retransmitted by each signal manipulator with a laser launch power that allows the signals to be received error free or with an error rate which is acceptable by conventional classical communication protocols at the adjacent signal manipulator (or at the end of the signal channel if there are no adjacent signal manipulators). For example, the a bit error rate may be 1E-09 or less. In a further embodiment, the launch power of each signal manipulator is sufficiently low as to limit Raman noise.

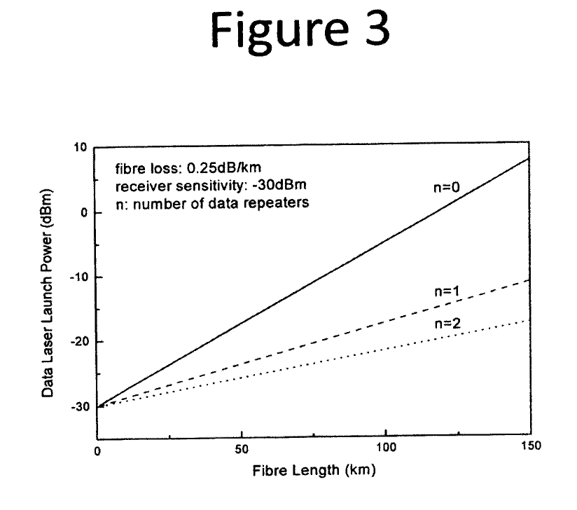

FIG. 3 shows the laser launch power required as a function of transmission distance for a classical signal. Results for a system where there are no repeaters is compared with that of a system comprising one signal manipulator according to an embodiment of the present invention, and a further system comprising two signal manipulators according to an embodiment of the present invention arranged in series. Assuming an excessive fibre loss of 0.25 dB/km and a standard telecom receiver sensitivity of −30 dBm, for 100 km, the minimum required launch power is −5 dBm for the case with no repeaters (n=0; solid line). For the case where the classical signal is retransmitted by a single signal manipulator (n=1; dashed line), the data is retransmitted by the signal manipulator after 50 km and hence only requires a minimum launch power of −17.5 dBm for a total transmission distance of 100 km. Similarly, when two signal manipulators according to an embodiment of the present invention are present (n=2; dotted line), the transmission distance before retransmission is reduced to 33 km, hence a launch power of only −21.7 dBm is required for a total transmission distance of 100 km.

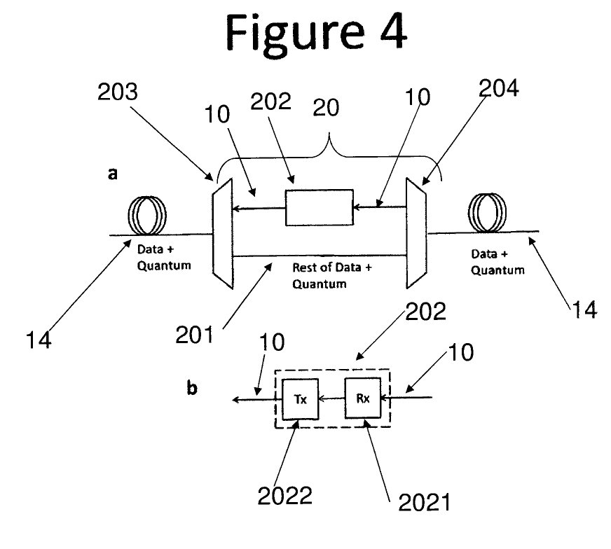

FIG. 4 shows a schematic of a signal manipulator 20 according to an embodiment of the present invention. The signal manipulator 20 comprises two spectral couplers 203 and 204, and a component 202 for receiving and retransmitting classical signal 10.

Multiplexed signal 14, comprising a classical signal 10 multiplexed with one or more other signals 201, including one quantum signal, is directed through signal manipulator 20. As signal 14 passes through the signal manipulator 20, spectral couplers 203 and 204 demultiplex apart and remultiplex together signals 10 and remaining signal 201 such that between spectral couplers 203 and 205, the signals are separated.

During transmission between spectral couplers 203 and 205, signal 10 is further directed through component 202 where it is received and retransmitted. Signal 201, by contrast is not directed into component 202.

In the embodiment of FIG. 4a, the multiplexed channel 14 is typically an optical fibre which interfaces directly with the spectral couplers 203 and 204. In an embodiment, spectral couplers 203 and 204 are add/drop multiplexers. In a further embodiment they are coarse wavelength division multiplexers or dense wavelength division multiplexers. Spectral couplers 203 and 204 further interface directly with classical data channel 10 and channel 201 which are typically optical fibres. Data channel 10 interfaces directly with component 202 which is typically a standard telecom transceiver.

In an embodiment the quantum signal is transmitted in the opposite direction to classical signal 10.

FIG. 4b shows a schematic of component 202 according to the embodiment of the present invention shown in FIG. 4a. Component 202 comprises a receiver 2021 and a transmitter 2022. Classical signal 10 is directed into component 202 and is received by receiver 2021. This in turn drives transmitter 2022 to transmit classical signal 10. Retransmitted signal 10 is then directed out of component 202.

In an embodiment, component 202 manipulates the classical signal 10 by one or more of amplification, signal re-timing, re-shaping and re-generation. It retransmits the signal at a higher power than the power at which it was received. In a further embodiment, the launch power of transmitter 2022 is sufficiently low as to limit Raman noise. In an embodiment, the launch power is less than or equal to −5 dBm.

In the embodiment of FIG. 4b, classical data channel 10 is typically an optical fibre which interfaces directly with component 202. Component 202 is typically a standard telecom transceiver comprising a standard telecom receiver 2021 and a standard telecom transmitter 2022.

In an embodiment component 202 is an optical signal manipulator which manipulates the signal by one or more of amplification, signal re-timing, re-shaping and re-generation. The signal manipulator may also manipulate the signal by a process other than amplification, signal re-timing, re-shaping or re-generation. Receiver 2021 receives optical signal 10 and 11 and converts said optical signal to an electrical signal. Transmitter 2022 receives said electrical signal and converts it to an optical signal.

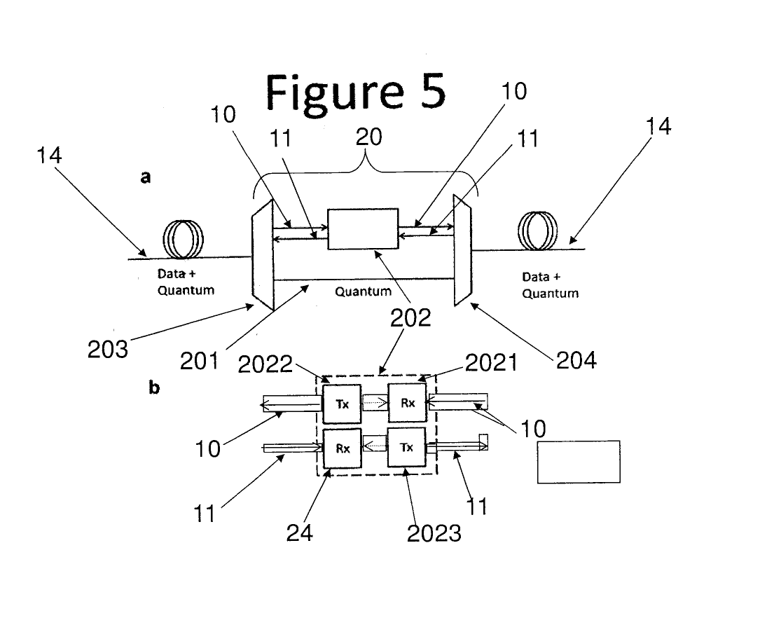

FIG. 5a shows a schematic of a signal manipulator 20 according to a further embodiment of the present invention. The signal manipulator 20 comprises two spectral couplers 203 and 204, and a component 202 for receiving and retransmitting classical signals 10 and 11 with opposite directionality.

Multiplexed signal 14, comprising classical signals 10 and 11 multiplexed with one or more other signals 201, comprising a quantum signal, is directed through signal manipulator 20. As signal 14 passes through the signal manipulator, spectral couplers 203 and 204 demultiplex apart and remultiplex together signals 10, 11 and remaining signal 201 such that between spectral couplers 203 and 205, the three signals are separated.

During transmission between spectral couplers 203 and 205, signals 10 and 11 are further directed through component 202 where they are received and retransmitted. Signal 201, by contrast, is not directed into component 202.

In the embodiment of FIG. 5a, the multiplexed channel (14) is typically an optical fibre which interfaces directly with the spectral couplers 203 and 204. In an embodiment, spectral couplers 203 and 204 are add/drop multiplexers. In a further embodiment they are coarse wavelength division multiplexers or dense wavelength division multiplexers. Spectral couplers 203 and 204 further interface directly with channels 10, 11 and 201 which are typically optical fibres. Data channels 10 and 11 interface directly with component 202 which is typically a standard telecom transceiver.

FIG. 5b shows a schematic of component 202 according to the embodiment of the present invention shown in FIG. 5a. 202 comprises two transmitters 2022 and 2023 and two receivers 2021 and 2024. Classical signal 10 is directed into component 202 and is received by receiver 2021. This in turn drives transmitter 2022 to transmit classical signal 10. Retransmitted signal 10 is then directed out of component 202. Likewise, classical signal 11 is directed into component 202 and is received by receiver 2023. This in turn drives transmitter 2024 to transmit classical signal 11. Retransmitted signal 11 is then directed out of component 202.

In an embodiment component 202 manipulates the classical signals 10 and 11 by and one or more of amplification, signal re-timing, re-shape and re-generation. The signal manipulator may also manipulate the signal by a process other than amplification, signal re-timing, re-shaping or re-generation. The signals are retransmitted such that the power at which they are retransmitted is higher than the one at which they were received. In a further embodiment, the launch power of transmitters 2022 and 2023 is sufficiently low to limit Raman scattering. In an embodiment, the launch power of transmitters 2022 and 2023 is less than or equal to −5 dBm.

In the embodiment of FIG. 5b, classical data channels 10 and 11 may be optical fibres which interface directly with component 202. In an embodiment component 202 may be a standard telecom transceiver comprising standard telecom receivers 2021 and 2024 and standard telecom transmitters 2022 and 2023.

In an embodiment component 202 is an optical signal manipulator. Receivers 2021 and 2024 receive optical signals 10 and 11 and convert said optical signals to electrical signals. Transmitters 2022 and 2023 receive said electrical signals and convert them to optical signals.

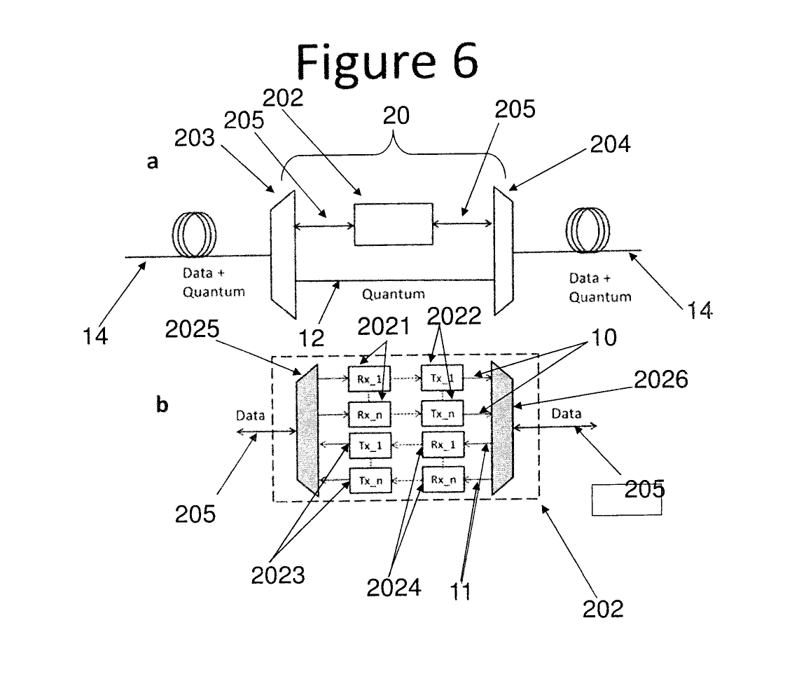

FIG. 6a shows a schematic of a signal manipulator 20 according to yet a further embodiment of the present invention. The signal manipulator 20 comprises two spectral couplers 203 and 204, and a component 202 for receiving and retransmitting classical signal 205.

Multiplexed signal 14, comprising bidirectional classical signal 205, itself comprising several classical channels 10 and 11, multiplexed with quantum channel 12 is directed through signal manipulator 20. In an embodiment, classical signal 205 comprises a mix of 40 or more classical components. In an embodiment, the classical signals are DWDM channels or reconfigurable optical add-drop multiplexer (ROADM) channels. ROADM channels are well known in the art and will not be discussed here.

As signal 14 passes through the signal manipulator, 20 spectral couplers 203 and 204 demultiplex apart and remultiplex together classical signal 205 and quantum signal 12 such that between spectral couplers 203 and 205, the two signals are separated.

During transmission between spectral couplers 203 and 205, classical signal 205 is further directed through component 202 where its component classical signals are received and retransmitted. Quantum signal 12, by contrast, is not directed into component 202.

In the embodiment of FIG. 6a, the multiplexed channel 14 is typically an optical fibre which interfaces directly with the spectral couplers 203 and 204. In an embodiment, spectral couplers 203 and 204 are add/drop multiplexers. In a further embodiment they are coarse wavelength division multiplexers. Spectral couplers 203 and 204 further interface directly with channels 205 and 12 which are typically optical fibres. Channel 205 interfaces directly with component 202.

FIG. 6b shows a schematic of component 202 according to the embodiment of the present invention shown in FIG. 6a. 202 comprises spectral couplers 2025 and 2026, a plurality of transmitters 2022 and 2023 and a plurality of receivers 2021 and 2024.

Classical signal 205, comprising a plurality of classical signals 10 and 11, is directed through component 202. As signal 205 passes through component 202, spectral couplers 2025 and 2026 demultiplex apart and remultiplex together the plurality of classical signals 10 and 11 such that between spectral couplers 2025 and 2026, the signals are separated.

During transmission between spectral couplers 2025 and 2026, the plurality of classical signals 10 are received by the plurality of receivers 2021. This in turn drives the plurality of transmitters 2022 to transmit classical signals 10. Likewise, the plurality of classical signals 11 are received by receiver 2023. This in turn drives transmitters 2024 to transmit classical signals 11.

In an embodiment, component 202 amplifies the plurality of classical signals 10 and 11 such that they are retransmitted at a higher power than the one at which they were received. In a further embodiment, the launch powers of the plurality of transmitters 2022 and 2024 are sufficiently low as to limit Raman scattering.

In the embodiment of FIG. 6b, classical data channel 205 is typically an optical fibre which interfaces directly with spectral couplers 2025 and 2026. In an embodiment, spectral couplers 2025 and 2026 are add/drop multiplexers. In a further embodiment they are dense wavelength division multiplexers. Spectral couplers 2025 and 2026 further interface directly with channels 10 and 11 which are typically optical fibres. Channels 10 and 11 each interface directly with a transceiver which is typically a standard telecom transceiver.

In an embodiment component 202 is an optical signal manipulator. Receivers 2021 and 2024 receive optical signals 10 and 11 and convert said optical signals to electrical signals. Transmitters 2022 and 2023 receive said electrical signals and convert them to optical signals.

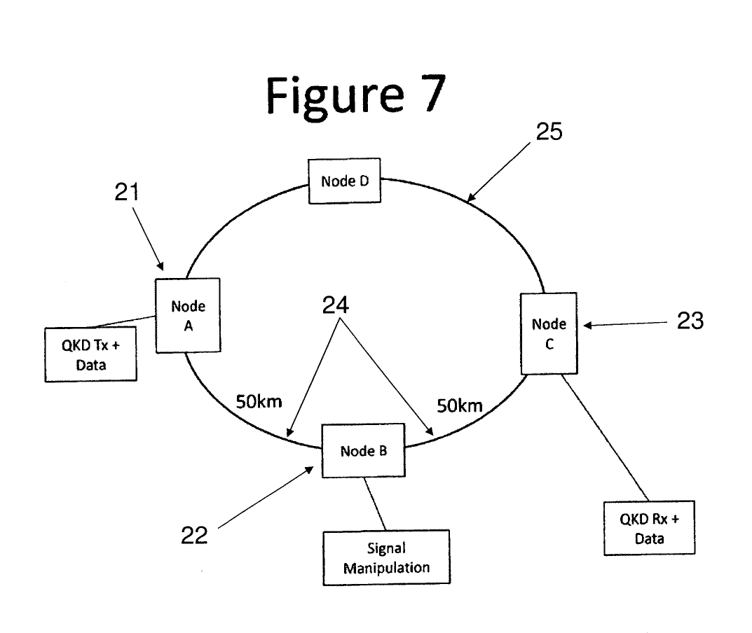

FIG. 7 shows the application of an embodiment of the signal manipulator of the present invention in a network scenario. In an embodiment, the network is a metropolitan network. In an embodiment, the network comprises a circular network of classical data channels 25 transmitting between four nodes of the network A, B, C and D and any combination thereof. Quantum key is transmitted from Node A (21) to Node C (22), a distance of 100 km. A signal manipulator 202 according to an embodiment of the present invention is located at Node B, 50 km from Node A and 50 km from Node C. At Node A, the quantum key signal enters the network and is multiplexed with other classical signals which are travelling through the network. At node C, the quantum key is removed from the multiplex and directed out of the network. Thus, a multiplexed channel 24 with quantum/classical coexistence is present between Nodes A and C. At Node B, the classical signal or signals are received by the signal manipulator from the multiplexed signal and retransmitted in the multiplexed signal. The presence of the signal manipulator at Node B thus enables the laser launch power of the classical data to be kept sufficiently low to limit Raman scattering, without compromising transmission distance.

In an embodiment, the metropolitan network of FIG. 7 is a wide area network.

In an embodiment, the circular network of classical data channels 25 is an optical fibre. The optical fibre interfaces directly with multiplexers at Node A (21) and Node C (23). In an embodiment these multiplexers are add/drop multiplexers. In a further embodiment they are coarse wavelength division multiplexers or dense wavelength division multiplexers. The multiplexers further interface directly with the multiplexed channel 24 which is typically an optical fibre. Multiplexed channel 24 interfaces directly with the signal manipulator according to an embodiment of the present invention at Node B.

The metropolitan network scenario of the above embodiment may be an existing classical network; the above embodiments allow a quantum network to be installed based on classical system infrastructure. Further, existing DWDM systems may employ intermediate line repeaters to compensate for loss in optical power. Such line repeaters can be straightforwardly adapted according to the above embodiments to enable quantum/classical coexistence over a long distance.

Existing methods of spectral filtering of Raman noise rely on specially designed and made filters which are expensive. All of the above embodiments can be implemented using readily available, commercial products, thus providing a cost advantage over other approaches.

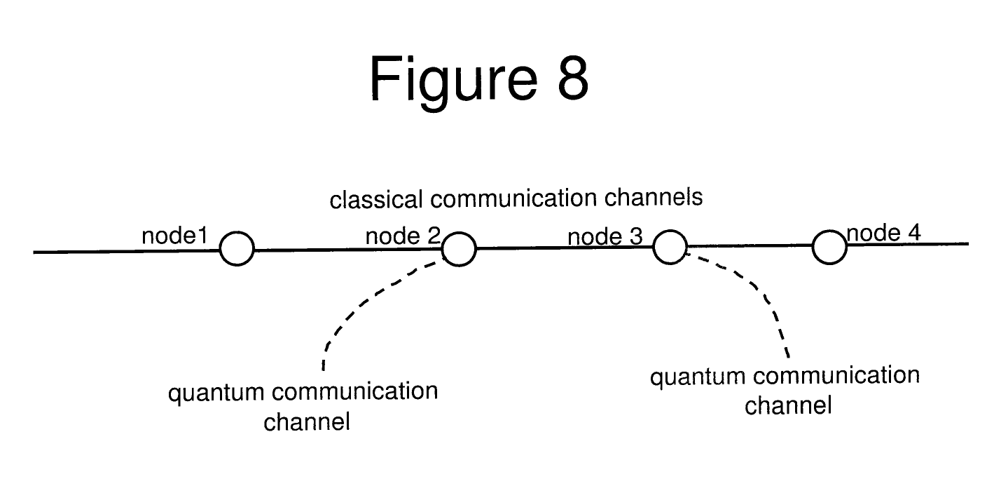

FIG. 8 shows the application of an embodiment of the signal manipulator as part of a long haul transmission link. Long haul transmission links are well known in the art and will not be discussed in detail here. Long haul transmission links are communication channels for communicating data over large distances. They can span up to several thousands of kilometres in length and typically comprise large numbers of intermediate notes which link sections of optical fibre. Conventionally, the intermediate nodes comprise optical amplifiers for boosting signals which have reached the node, prior to their retransmission.

The section of long haul transmission link shown in FIG. 8 comprises four nodes. Nodes 1 and 4 comprise an optical amplifier. Nodes 3 and 4 comprise signal manipulators according to an embodiment. Classical communication channels are transmitted along the entire length of the section of the transmission link shown. Between nodes 2 and 3, a quantum communication channel is multiplexed with the classical communication channels. The quantum communication channel is only multiplexed with the classical communication channels between nodes 2 and 3; outside of nodes 2 and 3, the quantum communication channel splits away from the long haul transmission link.

In an embodiment, the long haul transmission link comprises an optical fibre. In a further embodiment, the quantum communication channel comprises an optical fibre. In an embodiment, the optical fibre comprising the long haul transmission link interfaces directly with nodes 1, 2, 3 and 4. In a further embodiment, the optical fibre comprising the quantum communication channel interfaces directly with nodes 2 and 3.

In conventional long haul transmission links, quantum information cannot be transmitted through a node because amplification by a conventional optical signal amplifier causes errors in the quantum signal. In the embodiment of FIG. 8, however, nodes 2 and 3 comprise a signal manipulator according to an embodiment. Quantum information can therefore be transmitted through a long haul transmission link with the configuration shown in FIG. 8.

Configurations such as that shown in FIG. 8 may be used for QKD. While QKD cannot operate through optical amplifiers, a quantum signal manipulator according to an embodiment can be inserted in the node of a long haul transmission line to route/manipulate the classical signal in the place of an optical amplifier in a conventional transmission line. This allows QKD operation for a section of the fibre link. QKD can be readily used in a part of the long haul transmission fibre link, as long as the fibre section has no optical amplifier.

While certain embodiments have been described, these embodiments have been presented by way of example only, and are not intended to limit the scope of the inventions. Indeed, the novel methods, manipulators and systems described herein may be embodied in a variety of other forms; furthermore, various omission, substitutions and changes in the form of the methods, manipulators and systems described herein may be made without departing from the spirit of the inventions. The accompanying claims and their equivalents are intended to cover such form or modifications as would fall within the scope and spirit of the inventions.

1. A signal manipulator, comprising:
an input for multiplexed signal,
a demultiplexer for separating the multiplexed signal into separate components,
a retransmitter unit being configured to receive a first component from the separated components and retransmit said received first component at a higher power than it is received;
a bypass channel being configured to receive a second component from the components separated by the demultiplexer; and
a multiplexer for multiplexing the first and second components,
wherein the retransmitter is configured to regulate the power of the first component such that the power of the multiplexed signal leaving the multiplexer is −5 dBm or less.

2. A signal manipulator according to claim 1, wherein the retransmitter unit is configured to receive a plurality of components from said demultiplexer, the retransmitter unit being configured to regulate the power of received plurality of components such that the power of the multiplexed signal leaving the multiplexer is −5 dBm or less.

3. A signal manipulator according to claim 1, wherein said second component comprises a signal transmitted in the form of encoded weak light pulses, wherein the average number of photons in each weak light pulse is 500 or less.

4. A signal manipulator according to claim 1, wherein the first component has a retransmitted power in the range from −5 dBm to −40 dBm and wherein the second component has a power of −50 dBm or less.

5. A signal manipulator according to claim 1, wherein the retransmitter is configured to regenerate the first component for transmission.

6. A signal manipulator according to claim 1, wherein the retransmitter is configured to amplify the first component for transmission.

7. A signal manipulator according to claim 1, configured to manipulate signals travelling in a first direction and a second direction, wherein the first direction is opposite to the second direction, the retransmitter being configured to regulate the power of the first component regardless of whether it is travelling in the first direction or the second direction, the demultiplexer being configured to demultiplex multiplexed signals travelling in a first direction and pass them to the retransmitter, the demultiplexer being configured to multiplex signals received from the retransmitter and bypass channel travelling in a second direction, the multiplexer being configured to multiplex signals received from the retransmitter and bypass channel travelling in a first direction and to demultiplex multiplexed signals travelling in a second direction and pass them to the retransmitter.

8. A signal manipulator according to claim 3, wherein the retransmitter comprises a plurality of retransmission units arranged in parallel, such that each component is allocated to its own retransmission unit.

9. A signal manipulator according to claim 1, wherein the multiplexer, demultiplexer, retransmitter and bypass channel are provided by a reconfigurable add/drop multiplexer which is configured to regulate the power of the first component such that the power of the multiplexed signal leaving the multiplexer is −5 dBm or less.

10. A signal manipulator according to claim 1, further comprising a detector to determine the input power of the multiplexed signal and a processor configured to regulate the power of the first component such that the power of the multiplexed signal leaving the multiplexer is −5 dBm or less.

11. A quantum communication system comprising:
a source unit and a signal manipulator as recited in claim 1, said source unit comprising:
a source of quantum signals;
a source of classical signals; and
a mulitiplexing unit, configured to multiplex said quantum signals and said classical signals into a multiplexed signal;
the system further comprising an optical fibre configured to deliver said multiplexed signal from said source unit to said signal manipulator.

12. A quantum communication signal according to claim 11, wherein the source unit is configured to output said multiplexed signal with a power of −5 dBm or less.

13. A quantum communication system according to claim 11, further comprising a receiver for the signal which is output by the multiplexer of the signal manipulator.

14. A quantum communication system according to claim 13, comprising a plurality of signal manipulators according to claim 1.

15. A quantum communication system according to claim 14, wherein the signal manipulators are spaced such that there is 100 km or less between adjacent signal manipulators.

16. A quantum communication system according to claim 14, wherein the signal manipulators are spaced such that there is 10 km or more between adjacent signal manipulators.

17. A quantum communication system according to claim 14, wherein said plurality of signal manipulators are arranged in series.

18. A quantum communication system according to claim 14, wherein said system is a circular network.

19. A quantum communication network according to claim 14, wherein said system comprises a long haul transmission link with a length of at least 500 km.

20. A method of repeating a signal, the method comprising:
receiving a multiplexed signal,
demultiplexing the multiplexed signal into separate components,
receiving a first component of the demultiplexed signal and retransmitting said received first component at a higher power than it is received;
receiving a second component from the components separated by the demultiplexer and directing it into a bypass channel; and
multiplexing the first and second components to produce a multiplexed output signal,
wherein power at which the first component is retransmitted is controlled such that the power of the multiplexed output signal when leaving the multiplexer is −5 dBm or less.
